(19) United States
(12) Patent Application Publication
(10) Pub. No.: US 2003/0042359 A1
(43) Pub. Date: Mar. 6, 2003

(54) Equipment rack for wide body aircraft antenna system

(76) Inventor: Guy A. Lambiaso, Garden Grove, CA (US)

Correspondence Address: HARNESS, DICKEY & PIERCE, P.L.C., P.O. BOX 828, BLOOMFIELD HILLS, MI, 48303, US

(21) Appl. No.: 09/947,977

(22) Filed: Sep. 6, 2001

(51) Int. Cl. B64C 1/20; B64C 1/22; B64D 47/00

(52) U.S. Cl. 244/118.1

(57) ABSTRACT

An equipment rack fabricated from C-channel, flat plate and mechanical fasteners for installation and support of new or retrofit antenna equipment on wide body aircraft. The rack provides direct mechanical connection to aircraft structure, eliminating multipiece turnbuckle assemblies. Vertical rails and support braces each attach at a first end to a combination of flat plates and drip shields, the flat plates and drip shields supporting the antenna equipment. A second end of each vertical rail and support brace attaches directly to aircraft structure by mechanical fasteners. The equipment rack design provides a minimal part design, providing a lower cost for both the equipment rack and its installation.

### FIELD OF THE INVENTION

The present invention relates to the design, construction and installation of an equipment rack, and more particularly to the design, construction, and installation of an equipment rack supporting an antenna subsystem of a wide body aircraft.

### BACKGROUND OF THE INVENTION

The aircraft industry currently employs overhead racks normally attached to frames or frame structure to support systems and components adjacent to the frames of the aircraft. These racks are typically installed and attached to the frames or frame structure using adjustable mounts similar to turnbuckle assemblies which are purchased from outside vendors and utilized to provide position adjustment of the racks. For existing aircraft, system changes or new developments in the industry may require that new equipment be retrofitted in the aircraft adjacent to the frame structure. The new equipment may encounter items that were originally installed or also retrofitted after initial construction of the aircraft. There is a need for a simpler, less expensive system to retrofit equipment racks onto existing aircraft, particularly for operation in connection with new antennas installed on the aircraft.

The existing turnbuckle assembly used in present day aircraft applications typically employs a support member such as a vertical rail or diagonal brace, fixedly attached at a first end to the rack assembly, and a second end attached to a turnbuckle assembly having both a support member attachment end and a free end. The turnbuckle assembly free end in turn is attached to the aircraft structure via a cast or forged mounting pad, typically by a mechanical bolt or pin. The mount pad requires separate attachment to the aircraft structure, such structure typically being a frame or intercostal, by mechanical fastener means. This multi-piece assembly requires several fastener installation steps and an accurate location of the mount pad for the free end of the turnbuckle. If the mount pad is misaligned during initial installation, the turnbuckle and therefore the overhead rack installation process comes to a halt until either the rack arrangement or the mount pad can be relocated. This involves a significant time loss and a potential for mislocation of the overhead racks.

On wide body aircraft, two antennas are intended for retrofit on existing aircraft and proposed for installation on new aircraft. An overhead rack assembly is required to support the antenna drive system converter and power supply. This assembly must be located within about two (2) feet (0.61 meters) of each antenna. Due to the tight location spacing requirement, and the possibility of encountering existing or other retrofitted equipment adjacent to the antenna installation location(s), an alternative to the turnbuckle assembly to support the equipment rack(s) is needed. A simpler design requiring fewer parts, less expense, more rapid installation, and greater location flexibility of the equipment rack(s) is therefore required.

### SUMMARY OF THE INVENTION

The present invention addresses these and other drawbacks by providing a rack which is supported to the structure of the aircraft by the rigid structure of the rack itself. The equipment rack of the invention includes sheet metal, channel bracket and U-channel shaped members. One or a combination of threaded fasteners, rivets, or hole filling fittings are employed to install the rack assembly aboard the aircraft. In one embodiment of the invention, the assembly consists of several plates providing support for the antenna assembly equipment. The plates are supported by vertical members which attach directly to intercostals spanning between individual frames stringers(?) of the aircraft. Two sets of braces are then employed to diagonally support and restrain the assembly, each set positioned to restrain motion of the rack about a 90 degree axis. A first set of braces is employed to restrain forward/aft motion of the rack. This first set of braces attach to the lower rack area and extend diagonally upward to an intercostal. A second set of braces is employed to restrain inboard/outboard motion of the rack. This second set of braces attach in a perpendicular direction to the first set of braces. This second set of braces connect the lower rack assembly to the aircraft frames.

The use of U-shaped channels and flat plate for braces and bracket assemblies permit the preassembly of a rack with dimensions suitable for the location. Elimination of the multi-part turnbuckle assembly permits the assembler or installer to make modifications as required in the field. Modifications required for installation of the present invention consist of making simple cuts in the vertical rails or diagonal braces to vary the height or location of the rack(s), rather than the complicated use of the turnbuckle assemblies previously used.

In another aspect of this invention, additional support plates comprising a drip shield comprising a predominantly flat plate can be installed, which protects the electrical equipment installed on the rack and provides additional stiffness to the rack.

The present invention provides several advantages over the industry standard rack design. One advantage is the installer can locally make modifications quickly and inexpensively by simple material cut(s). Another advantage of the invention is to provide flexibility to locate the antenna equipment to suit existing installations. Yet another advantage of the invention is that racks can be preassembled and shipped to other installers or backfitters of aircraft equipment. Flexibility to account for different aircraft arrangements can also be provided for by utilizing assembly pieces of greater length than normally required for this type of an assembly. Field modification of the various parts including the diagonal braces and vertical support members can be made easily by an installer in the field.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The various advantages of the present invention will become apparent to one skilled in the art by reading the following specification and subjoined claims and by referencing the following drawings in which:

FIG. 1 is an perspective view showing the overall assembly of a typical rack in accordance with one aspect of the present invention;

FIG. 2 is an elevational view looking aft of the assembly of FIG. 1;

FIG. 3 is a side view looking outboard taken along Section line III-III of FIG. 2;

FIG. 4 is an exploded perspective view of a turnbuckle rack design, wherein the bracket assembly for the turnbuckle is mounted on a frame of an aircraft; and

FIG. 5 is an exploded perspective view of the turnbuckle rack design of FIG. 4 showing an alternate turnbuckle assembly mounted to an intercostal.

### DETAILED DESCRIPTION OF THE PREFERRED EMBODIMENTS

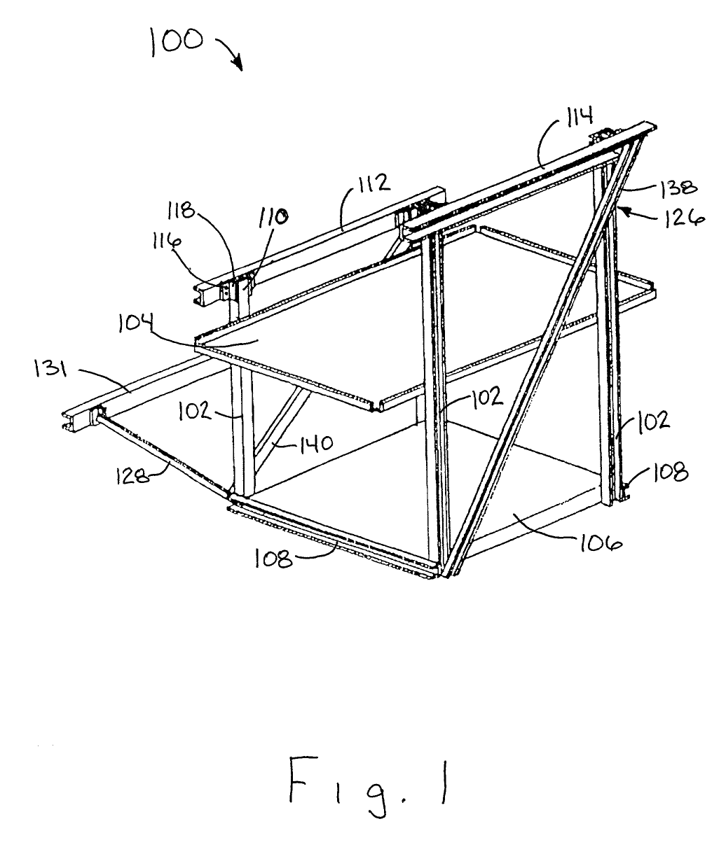

The following description of the preferred embodiments is merely exemplary in nature and is in no way intended to limit the invention, its application, or uses. Referring to FIG. 1, a rack assembly in accordance with a preferred embodiment of the present invention is shown. Rack assembly 100 comprises a vertical rail 102 arranged to support each corner of drip shield 104 and lower platform 106. Each vertical rail 102 comprises a rigid structural shape such as a U-channel, L-channel, or that of a rectangle. Drip shield 104 and lower platform 106 are plates which may be of any shape suitable for the equipment supported, and are generally square or rectangular in shape, and may have additional support members or edge bends for stiffness. At least one and preferably two horizontal supports 108 , each of the horizontal supports 108 having a similar shape to the vertical rail 102 shape, are spaced to support the widest dimension required for the equipment. An upper end 110 of each vertical rail 102 is fastened to either an outboard intercostal 112 or an inboard intercostal 114. Attachment of vertical rail 102 upper end 110 to outboard intercostal 112 or inboard intercostal 114 is by fasteners 116 direct to the intercostal(s), but may also be via a combination of fasteners 116 and angle brackets 118. A variety of fasteners 116 may be employed including screw type connectors, rivets, and hole filling fittings.

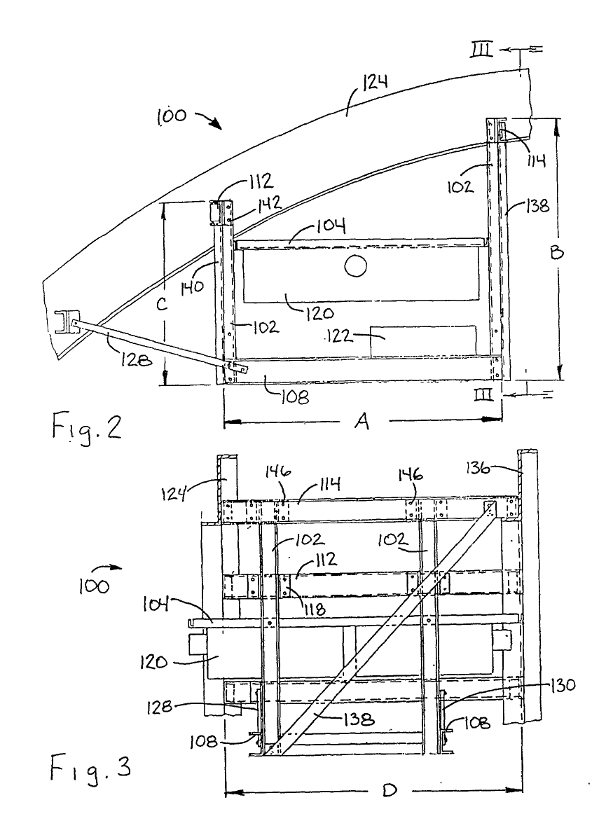

Referring now to FIG. 2, a view looking aft in a typical wide body aircraft is provided, showing a rack assembly of the present invention. FIG. 2 provides rack assembly 100, and an exemplary arrangement of equipment supported by a rack of the present invention. This equipment comprises at least a displacement converter 120 and a power supply 122. Dimension “A” is the rack width, controlled to provide a rack assembly width which provides the minimum space for the displacement converter 120 and the power supply 122. Dimension “B” represents the length of each inboard (long) vertical rail 102. Dimension “C” represents the length of each outboard (short) vertical rail 102. Dimension “B” and dimension “C” will vary for different rack installations and from aircraft to aircraft, therefore it is preferable to provide each vertical rail 102 with additional length which can be modified to suit installation and aircraft design tolerances.

Rack assembly 100 is supported from aircraft frame structure, such as frame 124 shown in FIG. 2. At least a pair of diagonal braces 126 comprising forward brace 128 and aft brace 130 (shown in FIG. 3) each diagonally support rack assembly 100 to an existing intercostal. Alternatively, an intercostal 131 is added for this purpose as shown in FIG. 1. Forward brace 128 and aft brace 130 provide inboard/outboard restraint of motion of rack assembly 100. Forward brace 128 and aft brace 130 are typically mechanically fastened at opposing ends of both braces to both rack assembly 100 and an intercostal, and are discussed in greater detail below.

Referring now to FIG. 3, frame 124 and adjacent frame 136 are shown, as are typical intercostals including outboard intercostal 112 and inboard intercostal 114. Outboard intercostal 112 and inboard intercostal 114 are both perpendicularly joined at an end of each intercostal to frame 124 and adjacent frame 136 by mechanical fasteners 116 and angle brackets 118. Inboard diagonal brace 138 joins the inboard forward corner of rack assembly 100 to inboard intercostal 114. Outboard diagonal brace 140, shown in FIG. 1, joins the outboard forward corner of rack assembly 100 to outboard intercostal 112. Inboard diagonal brace 138 and outboard diagonal brace 140, respectively, are positioned about 90 degrees from the orientation of forward brace 128 and aft brace 130, to restrain forward/aft motion of rack assembly 100.

Also shown in FIG. 3, Dimension “D” represents an example intercostal length. Intercostal length is determined by the spacing between frames which may vary from aircraft to aircraft or by aircraft section.

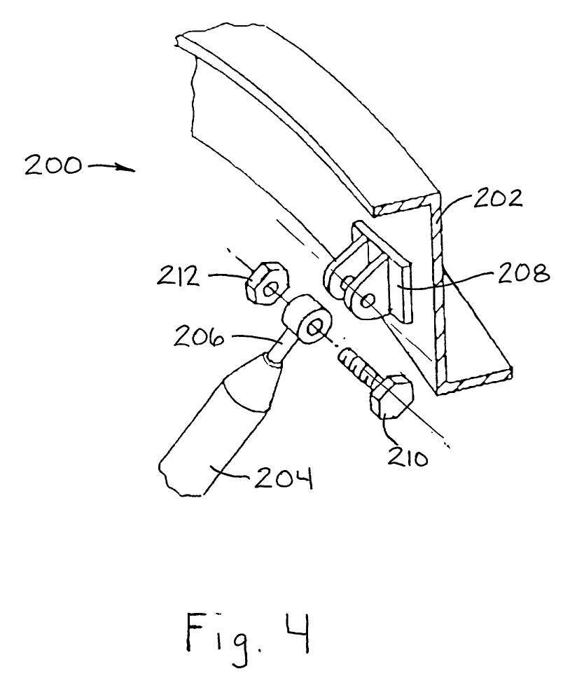

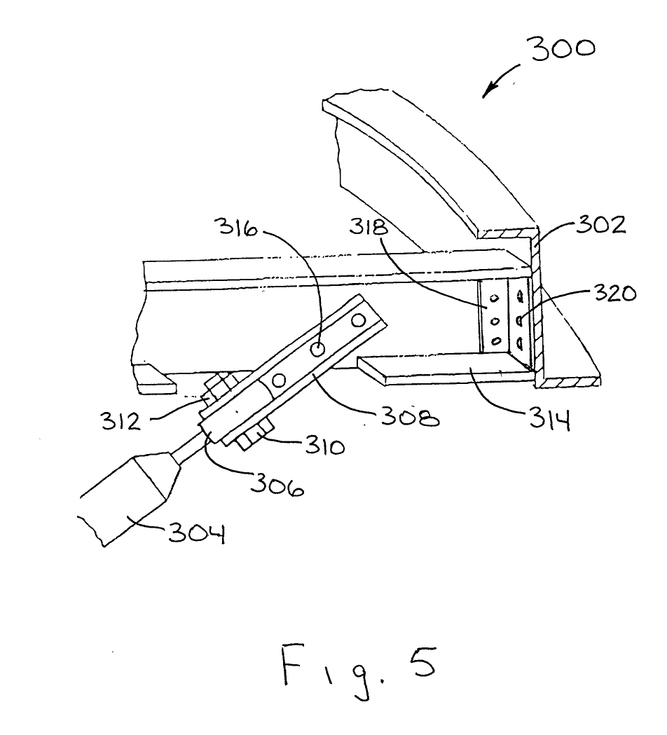

Referring to FIG. 4, support assembly 200, currently used by the aircraft industry to provide support of equipment to aircraft support structure, is shown. Frame 202 is a typical aircraft frame. Brace 204 is attached to the rack assembly (not shown). Turnbuckle 206 is attached at a first end to brace 204. A second end of turnbuckle 206 is attached to bracket 208. Bracket 208 is installed using mechanical fasteners to frame 202. The assembly of turnbuckle 206 to bracket 208 employs mechanical fasteners such as bolt 210 and nut 212, respectfully.

Referring to FIG. 5, an alternate configuration to support assembly 200 is shown with the turnbuckle assembly joining a rack to an intercostal of the aircraft. Support assembly 300 comprises a typical frame 302, brace 304 (similar to brace 204), a turnbuckle 306 (similar to turnbuckle 206) and a bracket 308 (similar to bracket 208). Fasteners comprising bolt 310 and nut 312 join turnbuckle 306 to bracket 308. Bracket 308 in this configuration is shown attached to intercostal 314 using mechanical fasteners 316. FIG. 5 also shows an angle bracket 318 typically used to join intercostal 314 to frame 302. Angle bracket 318 is fixedly attached to intercostal 314 with mechanical fasteners 320.

A key function of the invention is to provide the ability to locate the rack assembly 100 in close proximity, typically within two feet, of the antennas. The invention is suitable for use in wide body aircraft having sufficient vertical height in the overhead to accommodate the rack assembly. Typically two antennas are employed per plane, requiring at least two rack assemblies 100 per plane.

Previous attachment designs, support assembly 200 of FIG. 4, and support assembly 300 of FIG. 5, respectively, required pre-location of mount bracket 208 or mount bracket 308. Improper alignment of a mount bracket would preclude or delay rack installation. Additionally, the expense and assembly time associated with turnbuckle 206 or turnbuckle 306 installation is precluded by the invention use of direct fastening of the vertical rails and diagonal and forward braces to the plane structure.

Each vertical rail 102 may be precut to known dimension, or provided with additional stock length. This extra stock length may be easily removed to suit an existing installation space or interference with surrounding equipment or structure.

Referring back to FIGS. 1, 2 and 3, the mechanical fastening method for the invention is also shown. At least one clearance hole 142 is provided in each vertical rail 102 upper end 110 for mechanical fastener throughput. Mechanical fasteners 116 are each inserted through a clearance hole 142 to meet with either a pre-tapped or preformed mating hole 146 provided in inboard intercostal 114, outboard intercostal 112, frame 124 or frame 136. An angle bracket 118 may also be employed as required between each vertical rail 102 upper end 110 and inboard intercostal 1.14, outboard intercostal 112, frame 124 or frame 136.

At least a pair of diagonal braces 126, comprising forward brace 128, and aft brace 130, are attached in a similar manner as each vertical rail 102. Specifically, a first end of forward brace 128 is attached at the lower, forward, outboard corner of rack assembly 100, and a first end of aft brace 130 is attached at the lower, aft, outboard corner of rack assembly 100. A second end of forward brace 128 and a second end of aft brace 130 are each preferably connected to an existing intercostal (not shown), or a new intercostal 131 is added for this purpose, as shown in FIG. 1.

A first end of inboard diagonal brace 138 connects at the inboard, lower aft corner of rack assembly 100, and a first end of outboard diagonal brace 140 connects at the outboard, lower aft corner of rack assembly 100. A second end of inboard diagonal brace 138, and a second end of outboard diagonal brace 140 each connect to intercostals existing or added for this purpose in the aircraft. The preferred method is to attach the second end of inboard diagonal brace 138 to inboard intercostal 114, and the second end of outboard diagonal brace 140 to outboard intercostal 112.

The invention provides the advantages of a simpler equipment rack design, having fewer attachment parts, which in turn both reduces installation time and permits on-site adjustment for aircraft construction conditions. The invention also permits pre-construction of equipment racks off-site for shipment to refit facilities.

Those skilled in the art can now appreciate from the foregoing description that the teaching of the present invention can be implemented in a variety of forms. Therefore, while this invention has been described in connection with particular examples thereof, the true scope of the invention should not be so limited since other modifications will become apparent to the skilled practitioner upon a study of the drawings, specification, and following claims.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An equipment rack for supporting antenna control equipment from an aircraft comprising:
a framework assembly;
a plurality of rigid vertical rails each having a first end fixedly attached to the framework assembly and a second end fixedly attached to an internal structure of the aircraft; and
a plurality of braces each having a first end fixedly attached to the framework assembly and a second end fixedly attached to the internal structure of the aircraft.

2. The equipment rack of claim 1, wherein the internal structure of the aircraft comprises a first frame and a second frame.

3. The equipment rack of claim 2, wherein the internal structure of the aircraft further comprises at least one intercostal having a first end and a second end, each at least one intercostal first end fixedly attached to the first frame and each at least one intercostal second end fixedly attached to the second frame.

4. The equipment rack of claim 3, wherein the at least one intercostal further comprises a first intercostal and a second intercostal.

5. The equipment rack of claim 4, wherein the plurality of braces comprises a first pair of braces and a second pair of braces.

6. The equipment rack of claim 5, wherein the first pair of braces further comprises an inboard brace fixedly attached to the first intercostal, and an outboard brace fixedly attached to the second intercostal.

7. The equipment rack of claim 5, wherein the second pair of braces comprises a forward brace and an aft brace.

8. The equipment rack of claim 7 further comprising a third intercostal wherein the forward brace second end and the aft brace second end each are fixedly attached to the third intercostal.

9. An aircraft equipment rack for supporting an antenna control system comprising:
a drip shield;
a lower shelf;
a plurality of horizontal supports, said plurality of horizontal supports fixedly fastened to the lower shelf;
at least two intercostals;
a plurality of rigid vertical rails each having a lower end fixedly attached to the plurality of horizontal supports and an upper end fixedly attached to a pre-selected one of the at least two intercostals; and
a plurality of braces each having a first end fixedly attached to the plurality of horizontal supports and a second end fixedly attached to a preselected one of the pair of intercostals.

10. The aircraft equipment rack of claim 9 further comprising antenna support equipment fixedly attached to the lower shelf.

11. The aircraft equipment rack of claim 10 wherein the antenna support equipment comprises both a displacement converter and a power supply.

12. The aircraft equipment rack of claim 9 further comprising hole filling fasteners to fixedly attach said upper end of said plurality of rigid vertical rails to the pre-selected one of the at least two intercostals.

13. The aircraft equipment rack of claim 9 wherein the plurality of rigid vertical rails each comprise a predetermined length.

14. The aircraft equipment rack of claim 13 wherein the predetermined length comprises an arrangement allowance of the aircraft.

15. A wide body aircraft comprising:
a first frame;
a second frame adjacent to the first frame;
at least three intercostals, each having a first end perpendicularly fastened to the first frame, and a second end perpendicularly fastened to the second frame;
at least one equipment support plate;
a plurality of antenna support equipment fixedly attached to the at least one equipment support plate;
a plurality of rigid vertical rails each having a lower end fixedly attached to the at least one equipment plate, and an upper end fixedly attached to a predetermined one of the at least three intercostals; and
a plurality of braces, each having a first end fixedly attached to the at least one equipment support plate, and a second end fixedly attached to a predetermined one of the at least three intercostals.

16. The wide body aircraft of claim 14 further comprising an antenna having a support equipment mount range wherein the plurality of antenna support equipment is positioned within the support equipment mount range.
